(19) United States
(12) Patent Application Publication
(10) Pub. No.: US 2026/0071477 A1
(43) Pub. Date: Mar. 12, 2026

(54) Gate Opening Apparatus with Gear Assembly

(71) Applicant: Qianliang QIU, Pasadena, CA (US)

(72) Inventor: Qianliang QIU, Pasadena, CA (US)

(21) Appl. No.: 19/394,837

(22) Filed: Nov. 19, 2025

Related U.S. Application Data
(63) Continuation-in-part of application No. 19/057,800, filed on Feb. 19, 2025.
Application No. 19/057,800 is a division of application No. 18/530,097, filed on Dec. 5, 2023, now Pat. No. 12,247,430.

(51) Int. Cl. E05F 15/622; E06B 11/02

(52) U.S. Cl. CPC E05F 15/622; E06B 11/022; E05Y 2900/40

(57) ABSTRACT

A gate opening apparatus includes a housing, a supporting frame, a motor, a driving member connected to the motor, and a gear assembly. The gear assembly includes a main gear rotatably mounted on the supporting frame and connects to the driving member, and a plurality of driven gears rotatably mounted on the supporting frame. The gate opening apparatus is arranged to be selectively operated between a power mode and a manual mode, wherein in the power mode, the motor is electrically activated to drive the driving member and the main gear to rotate so as to drive the driven gears to rotate and move the door gate to slide, wherein in the manual mode, the motor is cut off from electricity and is arranged to exert minimal mechanical resistance so that a user is able to manually slide the door gate for opening or closing thereof.

### CROSS REFERENCES OF RELATED APPLICATIONS

This is a Continuation-In-Part application of a non-provisional application having an application number of Ser. No. 19/057,800, and a filing date of Feb. 19, 2025, which is a divisional application of a non-provisional application having an application number of Ser. No. 18/530,097 and a filing date of Dec. 5, 2023, the entire contents of which is hereby incorporated by reference.

### BACKGROUND OF THE PRESENT INVENTION

### Field of Invention

The present invention relates to a gate opening apparatus, and more particularly to a gate opening apparatus which is capable of allowing manual opening and closing of a gate when electricity is cut off.

### Description of Related Arts

A conventional gate opening apparatus for actuating a pivotal movement of a door gate usually comprises an elongated outer housing having one end portion mounted on a supporting object such as a supporting column, a motor mounted in the outer housing, a gear assembly provided in outer housing, a clutching device coupled between the motor and the actuating mechanism, and a driving member connecting between the gear assembly and the door gate. During operation, the motor is activated to drive the door gate to move pivotally so as to drive the door gate to “open” or “close” at a designated space.

A main disadvantage in association with the above-mentioned gate opening apparatus is that the clutching device is utilized to allow manual operation of the door gate when electricity to the gate opening apparatus is cut off. When there is no electricity, the door gate cannot be manually opened or closed unless the clutching device is disengaged so as to disengage the gear assembly from the motor. However, the procedures of engaging or disengaging the clutching device is very troublesome and involve complicated mechanical steps. These steps may be easy for a trained technician. However, they are deemed complicated to a lay person who is usually an ordinary purchaser or a user of the conventional gate opening apparatus. As a result, the user may need the assistance of a technician for activating the manual operation of the gate opening apparatus. However, the assistance may not be available during non-business hours and this may bring extreme inconvenience to the user when the door gate cannot be manually opened or closed. What worse is that in some conventional gate opening apparatuses, a manual operation mode may not be available at all.

As a result, there is a need to improve upon the conventional gate opening apparatuses so as to resolve the above-mentioned problem.

### SUMMARY OF THE PRESENT INVENTION

Certain variations of the present invention provide a gate opening apparatus which is capable of allowing manual opening and closing of a gate when electricity is cut off.

Certain variations of the present invention provide a gate opening apparatus which does not utility any clutching device in achieving manual operation of the door gate.

In one aspect of the present invention, it provides a gate opening apparatus for a door gate, comprising:
a housing having a supporting portion connected to an external anchor, and a mounting portion extending toward the door gate, the housing having a receiving cavity and an engagement slot communicating the receiving cavity with an exterior of the housing;
a motor received in the receiving cavity of the housing;
a gear assembly, which comprises:
a gear rod having one end connected to the motor without connecting through any clutching device, and another end extending in the receiving cavity toward the mounting portion of the housing, the gear rod having a plurality of first teeth spirally formed thereon; and
a driven member having a plurality of second teeth engaging with the first teeth of the gear rod, in such a manner that when the gear rod is driven to rotate, the driven member is arranged to move along a longitudinal direction of the housing, the driven member being connected to the door gate;
wherein the gate opening apparatus is arranged to be selectively operated between a power mode and a manual mode, wherein in the power mode, the motor is electrically activated to drive the gear rod to rotate so as to drive the driven member to move along a longitudinal direction of the housing for driving the door gate to move in a pivotal manner with respect to the external anchor, wherein in the manual mode, the motor is cut off from electricity and is arranged to exert minimal mechanical resistance so that a user is able to manually move the door gate for opening or closing thereof.

In another aspect of the present invention, it provides a gate opening apparatus for a door gate, comprising:
a housing having a receiving cavity and an engagement slot communicating the receiving cavity with an exterior of the housing;
a supporting frame received in the receiving cavity, the supporting frame having a top panel, a gear panel, and an operation cavity formed underneath the top panel, the operation cavity communicating with the receiving cavity of the housing;
a motor supported by the supporting frame, and accommodated in the receiving cavity;
a driving member connected to the motor in a rotatably movable manner; and
a gear assembly, which comprises:
a main gear rotatably supported by the top panel of the supporting frame and connecting to the driving member, in such a manner that when the driving member is driven by the motor to rotate, the main gear is also driven to rotate; and
a plurality of driven gears rotatably mounted on the gear panel of the supporting frame, the driven gears connecting to the main gear and the door gate, so that when the main gear is driven to rotate, the driven gears are also driven to rotate and drive the door gate to slide; and
wherein the gate opening apparatus is arranged to be selectively operated between a power mode and a manual mode, wherein in the power mode, the motor is electrically activated to drive the driving member to rotate so as to drive the main gear to rotate so as to drive the driven gears to rotate and move the door gate to slide, wherein in the manual mode, the motor is cut off from electricity and is arranged to exert minimal mechanical resistance so that a user is able to manually slide the door gate for opening or closing thereof.

This summary presented above is provided merely to introduce certain concepts and not to identify any key or essential features of the claimed subject matter.

### BRIEF DESCRIPTION OF THE DRAWINGS

FIG. 1 a schematic diagram of a gate opening apparatus according to a first preferred embodiment of the present invention.

FIG. 2 is a perspective view of the gate opening apparatus according to the first preferred embodiment of the present invention.

FIG. 3 is a bottom exploded perspective view of the gate opening apparatus according to the first preferred embodiment of the present invention.

FIG. 4 is an enlarged diagram of a driven member of a gear assembly of the gate opening apparatus according to the first preferred embodiment of the present invention.

FIG. 5 is schematic diagram illustrating an operation of the gate opening apparatus, wherein a door gate is driven to a closed position.

FIG. 6 is schematic diagram illustrating an operation of the gate opening apparatus, wherein the door gate is driven to an opened position.

FIG. 7 is a schematic diagram illustrating the interaction between a motor, a range adjustment mechanism and a control module according to the first preferred embodiment of the present invention.

FIG. 8 is a perspective view of a gate opening apparatus according to the second preferred embodiment of the present invention.

FIG. 9 is an exploded perspective view of a gate opening apparatus according to the second preferred embodiment of the present invention.

FIG. 10 a perspective view of a supporting frame of the gate opening apparatus according to the second preferred embodiment of the present invention.

FIG. 11 is a side view of the supporting frame of the gate opening apparatus according to the second preferred embodiment of the present invention.

FIG. 12 is a top view of the supporting frame of the gate opening apparatus according to the second preferred embodiment of the present invention.

FIG. 13 is a front view of the supporting frame of the gate opening apparatus according to the second preferred embodiment of the present invention, illustrating an enlarged view of an actuation chain.

FIG. 14 is a schematic diagram illustrating the interaction between a motor, a range adjustment mechanism and a control module according to the second preferred embodiment of the present invention.

FIG. 15 is a schematic diagram illustrating the interaction between a gate opening apparatus of the present invention and the door gate.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

It should be appreciated that the terms “length”, “width”, “top”, “bottom”, “front”, “rear”, “left”, “right”, vertical”, “horizontal”, “upper”, “lower”, “exterior”, and “interior” in the following description refer to the orientation or positioning relationship in the accompanying drawings for easy understanding of the present invention without limiting the actual location or orientation of the present invention. Therefore, the above terms should not be an actual location limitation of the elements of the present invention.

It should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection can refer to permanent connection or detachable connection. Therefore, the above terms should not be an actual connection limitation of the elements of the present invention.

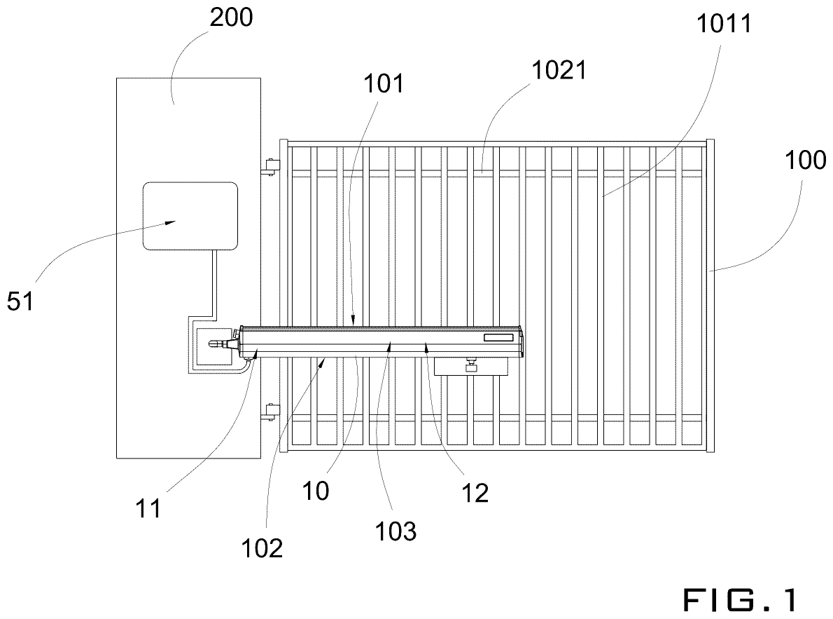

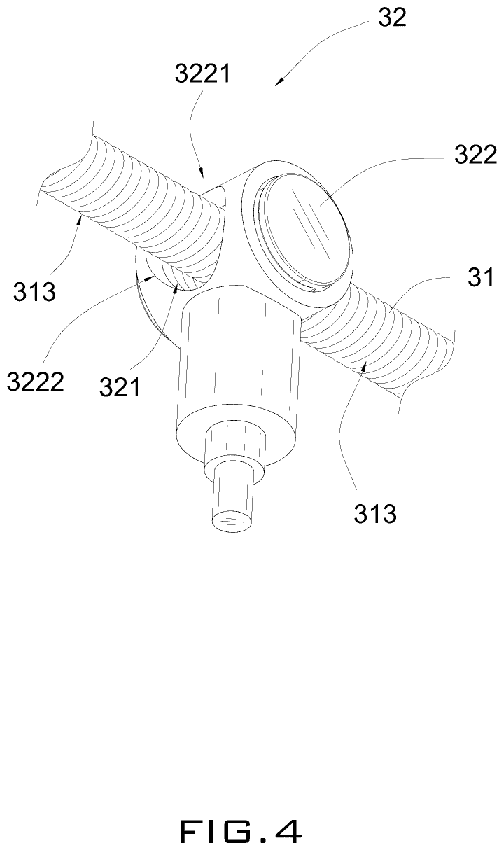

Referring to FIG. 1 to FIG. 6 of the drawings, a gate opening apparatus according to a preferred embodiment of the present invention is illustrated. Broadly, the gate opening apparatus may comprise a housing 10, a motor 20, and a gear assembly 30. The gate opening apparatus of the present invention is for pivotally opening or closing a door gate 100.

The housing 10 may have a supporting portion 11 connected to an external anchor 200 such as a column or a wall provided near the door gate 100, and a mounting portion 12 extending toward the door gate 100. The housing 10 may have a receiving cavity 13 and an engagement slot 14 communicating the receiving cavity 13 with an exterior of the housing 10.

The motor 20 may be received in the receiving cavity 13 of the housing 10. The gear assembly 30 may comprise a gear rod 31 and a driven member 32. The gear rod 31 may have a first end 311 connected to the motor 20 without connecting through any clutching device, and a second end 312 extending in the receiving cavity 13 along the mounting portion 12 of the housing 10. The gear rod 31 may have a plurality of first teeth 313 spirally formed thereon.

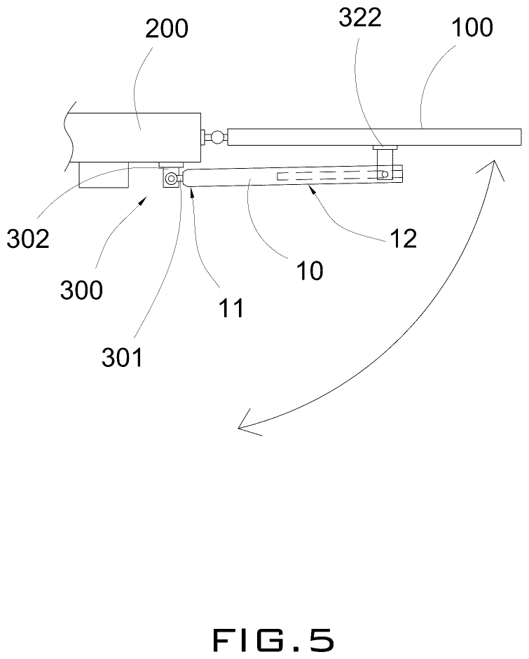

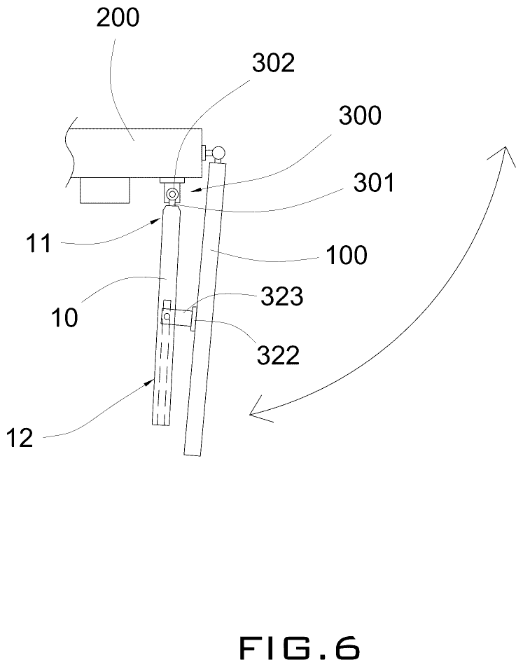

The driven member 32 may have a plurality of second teeth 321 engaging with the first teeth 313 of the gear rod 31, in such a manner that when the gear rod 31 is driven to rotate, the driven member 32 may be arranged to move along a longitudinal direction of the gear rod 31 and the housing 10. The driven member 32 may be connected to the door gate 100, as shown in FIG. 1, and FIG. 5 to FIG. 6 of the drawings.

The gate opening apparatus of the present invention may be arranged to be selectively operated between a power mode and a manual mode, wherein in the power mode, the motor 20 may be electrically activated to drive the gear rod 31 to rotate so as to drive the driven member 32 to move along a longitudinal direction of the housing for driving the door gate 100 to move in a pivotal manner with respect to the external anchor 200, wherein in the manual mode, the motor 20 is cut off from electricity and is arranged to exert minimal mechanical resistance so that a user is able to manually move the door gate 100 for opening or closing thereof.

According to the preferred embodiment of the present invention, the gate opening apparatus may be utilized for a door gate 100 having an elongated structure. The door gate 100 may comprise a plurality of transverse members 1011 and a plurality of longitudinal members 1021 and may pivotally move on a ground surface, with or without being assisted by a plurality of wheels. The external anchor 200 may be a supporting member for supporting the gate opening apparatus. The external anchor 200 may be a column, an external wall, or other suitable structures.

The housing 10 may be configured from metallic material and may be elongated in shape. The supporting portion 11 may be a corresponding end portion of the housing 10, while the mounting portion 12 may extend from the supporting portion 11. The supporting portion 11 may be mounted on the external anchor 200, while the mounting portion 12 may extend along a longitudinal direction of the door gate 100. In order to facilitate pivotal movement of the door gate 100, the supporting portion 12 of the housing 10 may be pivotally mounted with respect to the external anchor 200, preferably through a joint assembly 300 comprising a first pivotal arm 301 outwardly and longitudinally extending from the supporting portion 11, and a second pivotal arm 302 pivotally connecting between the external anchor 200 and the first pivotal arm 301.

As shown in FIG. 1 to FIG. 3 of the drawings, the housing 10 may extend alongside the door gate 100 with the supporting portion 11 pivotally mounted on the external anchor 200. More specifically, the housing 10 may have a top side 101, a bottom side 102, a front side 103 and a rear side 104 to form a substantially rectangular structure, wherein the engagement slot 14 may be formed on the bottom side 102 of the housing 10 along a longitudinal direction thereof. The rear side 104 of the housing 10 may be arranged to extend alongside the door gate 100. In this preferred embodiment of the present invention, the mounting portion 12 of the housing 10 may be pivotally connected to the door gate 100 at a distance from the external anchor 200.

The motor 20 may be supported in the receiving cavity 13 of the housing 10 at the supporting portion 11 thereof. The motor 20 may be configured as a synchronous motor and may be arranged to drive the gear assembly 30 to rotate. A feature of the motor 20 is that when the motor 20 is connected to a power source, such as a powered control unit (described below), the motor 20 may be arranged to possess a predetermined amount of mechanical resistance so as to prevent users from manually opening or closing the door gate 100. In other words, in normal situation, the door gate 100 will be fully controlled by the gate opening apparatus and users may be prevented from manually opening or closing the door gate 100 due to the mechanical resistance of the motor 20.

The gear assembly 30 may be operatively coupled to the motor 20. More specifically, the gear rod 31 may have the first end 311 connected to the motor 20, and the second end 312 extending from the first end 311 toward the mounting portion 12 of the housing 10. When the motor 20 is actuated, the gear rod 31 may rotate accordingly.

The driven member 32 may be movably coupled to the gear rod 31 in such a manner that when the gear rod 31 is driven to rotate, the driven member 32 may be driven to move along a longitudinal direction of the gear rod 31.

The driven member 32 may comprise an engagement body 322 having a through hole 3221, wherein the second teeth 321 may be formed on a circumferential boundary 3222 of the through hole 3221. The gear rod 31 may be arranged to pass through the through hole 3221, in such a manner that the first teeth 313 may engage with the second teeth 321. Thus, when the gear rod 31 is driven to rotate, the engagement body 322 may be driven to move along the longitudinal direction of the gear rod 31.

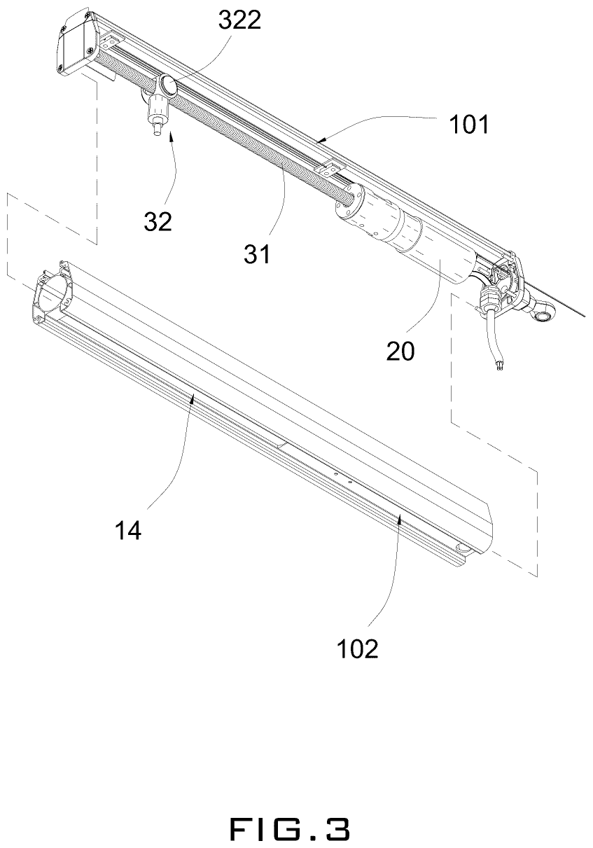

As shown in FIG. 3 of the drawings, the engagement body 322 may be configured as having a cylindrical or cubic structure and may be arranged to extend out of the engagement slot 14 so as to partially expose out of the receiving cavity 13. Note that the geometrical shape of the engagement body 322 may be varied to fit different circumstances in which the present invention is manufactured or operated.

Furthermore, the driven member 32 may further comprise a coupling arm 323 pivotally connecting the engagement body 322 to the door gate 100 so that when the engagement body 322 is driven to move along the gear rod 31, the coupling arm 323 may transmit the mechanical force to the door gate 100 and tend to pivotally open or close the door gate 100 with respect to the external anchor 200. The coupling arm 323 may be securely connected to the door gate 100 by conventional mechanical methods, such as welding, using screws or other methods.

The gate opening apparatus may further comprise a range adjustment mechanism 40 provided on the housing 10 for setting a range of motion of the driven member 32. Specifically, the range adjustment mechanism 40 may comprise a sliding track 41 mounted on the top side 101 of the housing 10, and a first and a second adjustment sliders 42, 43 slidably mounted on the sliding track 41. The first adjustment slider 42 and the second adjustment slider 43 may be spaced apart from each other on the sliding track 41, wherein a distance between the first adjustment slider 42 and the second adjustment slider 43 may dictate the range of motion on the part of the driven member 32.

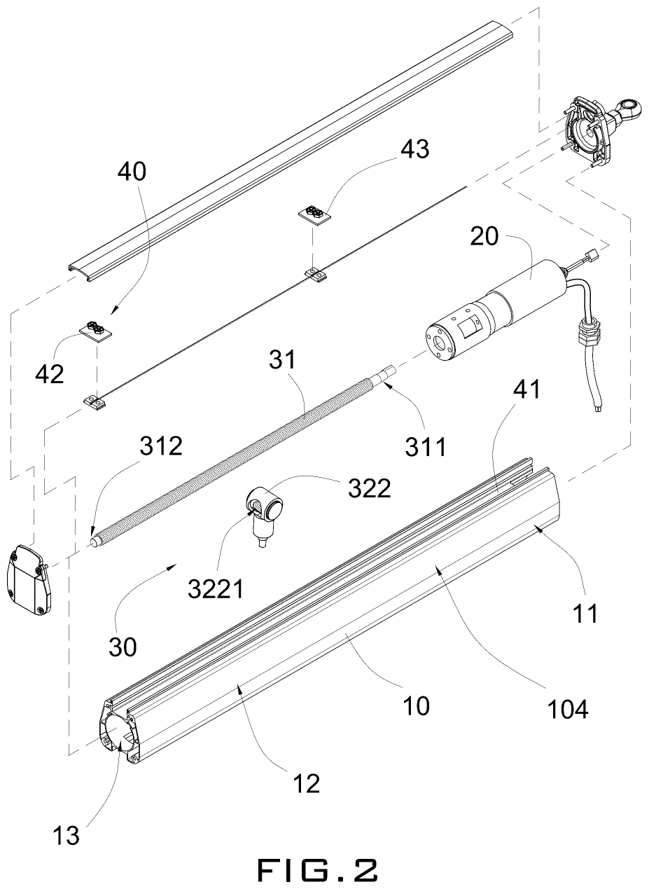

Referring to FIG. 2 of the drawings, each of the first adjustment slider 42 and the second adjustment slider 43 may be adjustably and slidably mounted on the sliding track 41 so that each of them may be locked in position, or unlocked to freely slide on the sliding track 41. A plurality of markings may be provided on the sliding track 41 so that a user may be able to observe the positions of each of the first adjustment slider 42 and the second adjustment slider 43 with respect to the sliding track 41.

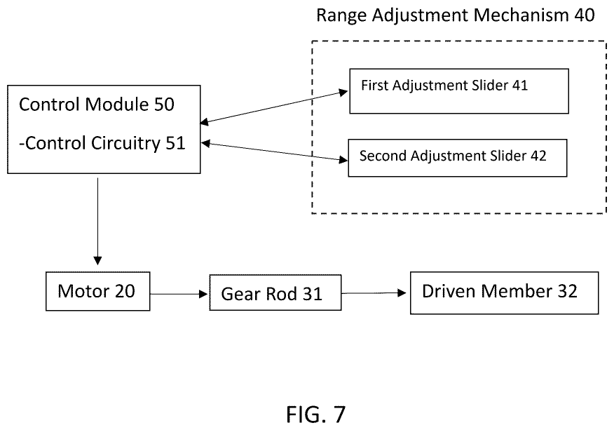

As shown in FIG. 7 of the drawings, the gate opening apparatus may further comprise a control module 50 which may comprise a control circuitry 51 electrically connected to the motor 20 and the range adjustment mechanism 40 for controlling a driving operation of the motor 20. The control circuitry 51 may be mounted and physically protected in a protective box 51 which may be mounted on the external anchor 200.

The control circuitry 51 may be electrically connected to the motor 20 so that it may activate the operation thereof. When the gate opening apparatus is in the power mode, the control circuitry 51 may activate the motor 20 so as to drive the motor 20 to rotate in a predetermined direction. The rotation of the motor 20 may drive the gear rod 31 to rotate as well and this in turn drive the driven member 32 to move along the gear rod 31. Since the driven member 32 may be pivotally connected to the door gate 100 through the coupling arm 323, the linear movement of the driven member 32 along the gear rod 31 may drive the door gate 100 to pivotally move with respect to the external anchor 200.

Furthermore, each of the first adjustment slider 42 and the second adjustment slider 43 may be electrically connected to the control circuitry 51. Each of the first adjustment slider 42 and the second adjustment slider 43 may be in magnetic communication with the driven member 32 so that when the driven member 32 is moved to one of the first adjustment slider 42 and the second adjustment slider 43, electrical signals may be transmitted to the control circuitry 51 for deactivating the motor 20. This may have the effect of stopping the rotation of the gear rod 31 and the driven member 32 so as to stop the pivotal movement of the door gate 100.

The control circuitry 51 may be configured to activate the motor 20 again to drive the gear rod to rotate in opposite direction so as to drive the door gate 100 to pivotally close or to pivotally open when the user desires.

In the power mode, the motor 20 may be arranged to exert substantial resistance so that a user may not be able to manually pull or push the door gate 100 for pivotally moving it. In other words, when the gate opening apparatus is in normal operation, manual opening or closing the door gate 100 will not be allowed.

When the gate opening apparatus is in the manual mode, the supply of electricity to the motor 20 is cut off. The substantial resistance possessed by the motor 20 will ceases to exist without any involvement of clutching device so that a user is able to manually push or pull the door gate 100 so as to allow the door gate 100 to move pivotally with respect to the external anchor 200. It is important to mention that this feature is distinctive with respect to conventional gate opening apparatuses in which clutching devices must be used when electricity is cut off for allowing manual movement of the corresponding door gate.

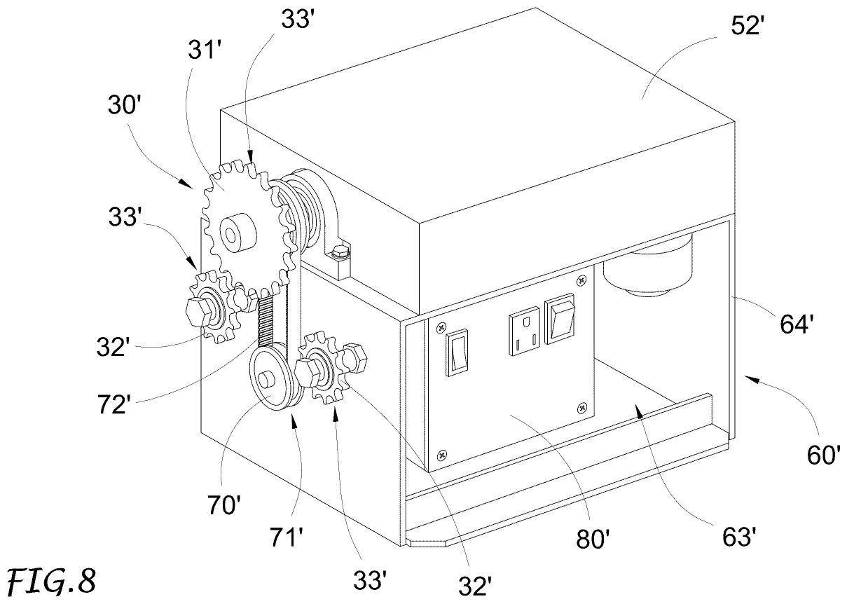

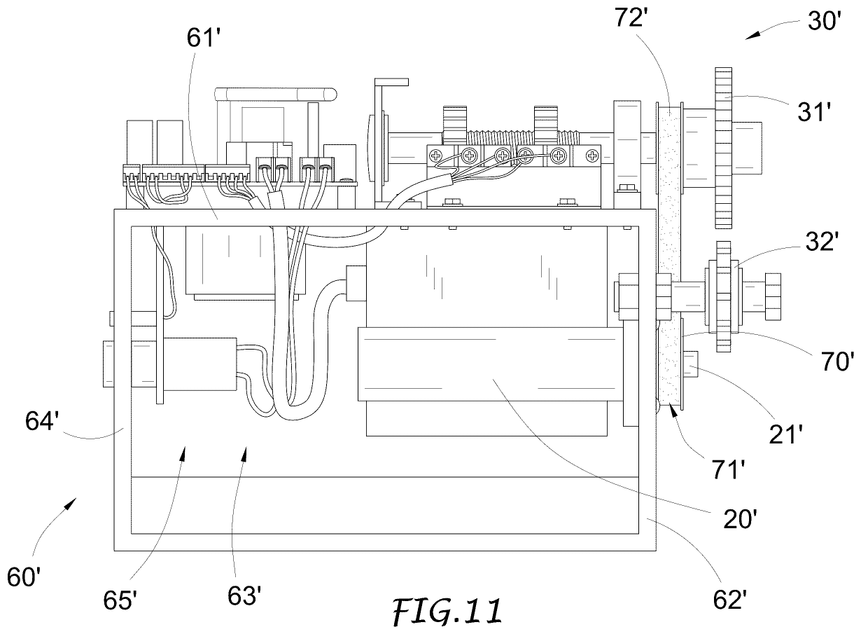

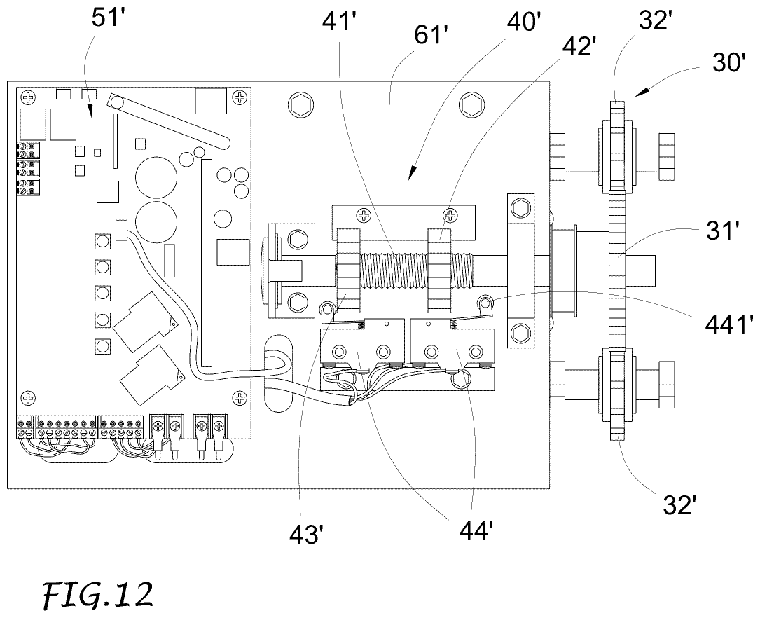

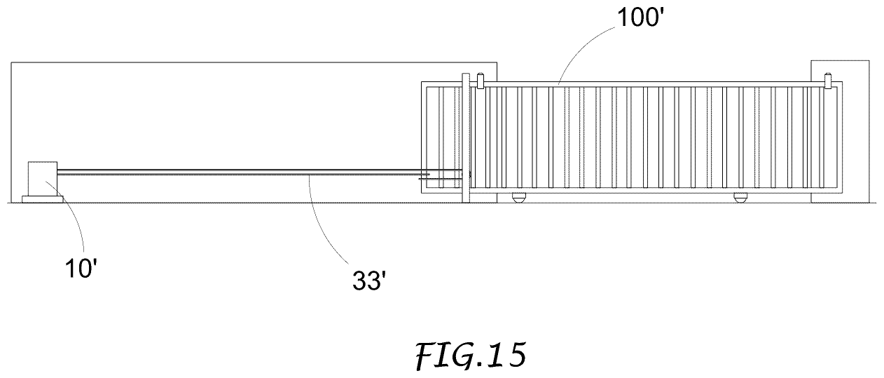

Referring to FIG. 8 to FIG. 15 of the drawings, a gate opening apparatus according to a second preferred embodiment of the present invention is illustrated. In this second preferred embodiment, the gate opening apparatus may be utilized for opening or closing a door gate 100 by driving the door gate 100 to slide along a flat surface, such as on a ground surface. Broadly, the gate opening apparatus may comprise a housing 10′, a supporting frame 60′, a motor 20′, a driving member 70′, and a gear assembly 30′.

The housing 10′ may have a receiving cavity 11′ and an engagement slot 12′ communicating the receiving cavity 10′ with an exterior of the housing 10′.

The supporting frame 60′ may be received in the receiving cavity 11′. The supporting frame 60′ may have a top panel 61′, a gear panel 62′, and an operation cavity 63′ formed underneath the top panel 61′. The operation cavity 63′ may communicate with the receiving cavity 11′ of the housing 10′.

The motor 20′ may be supported by the supporting frame 60′, and may be accommodated in the receiving cavity 11′ of the housing 10′.

The driving member 70′ may be connected to the motor 20′ in a rotatably movable manner.

The gear assembly 30′ may comprise a main gear 31′ and a plurality of driven gears 32′. The main gear 31′ may be rotatably supported by the top panel 61′ of the supporting frame 60′ and may connect to the driving member 70′, in such a manner that when the driving member 70′ is driven by the motor 20′ to rotate, the main gear 31′ may also be driven to rotate correspondingly.

The driven gears 32′ may be rotatably mounted on the gear panel 62′ of the supporting frame 60′. Moreover, the driven gears 32′ may connect to the main gear 31′ and the door gate 100′, so that when the main gear 31′ is driven to rotate, the driven gears 32′ may also be driven to rotate and drive the door gate 100′ to slide in a corresponding direction.

The gate opening apparatus may be arranged to be selectively operated between a power mode and a manual mode, wherein in the power mode, the motor 20′ may be electrically activated to drive the driving member 70′ to rotate so as to drive the main gear 31′ to rotate so as to drive the driven gears 32′ to rotate and move the door gate 100 to slide, wherein in the manual mode, the motor 20′ may be cut off from electricity and is arranged to exert minimal mechanical resistance so that a user is able to manually slide the door gate 100 for opening or closing thereof.

According to the second preferred embodiment of the present invention, the door gate 100 may also have an elongated structure. The door gate 100 may comprise a plurality of transverse members 1011 and a plurality of longitudinal members 1021 and may slide on a ground surface, preferably assisted by a plurality of wheels.

The housing 10′ may be configured from rigid material, such as metallic or plastic material. As shown in FIG. 1 of the drawings, the housing 10′ may form a rectangular structure. The housing 10′ may have two engagement slots 12′ formed on two sidewalls 13′ thereof. The gear assembly 30′ may drive the door gate 100′ to open or close through the engagement slots 12′ (described in more details below). The housing 10′ may be disposed on a ground surface and in front of the door gate 100.

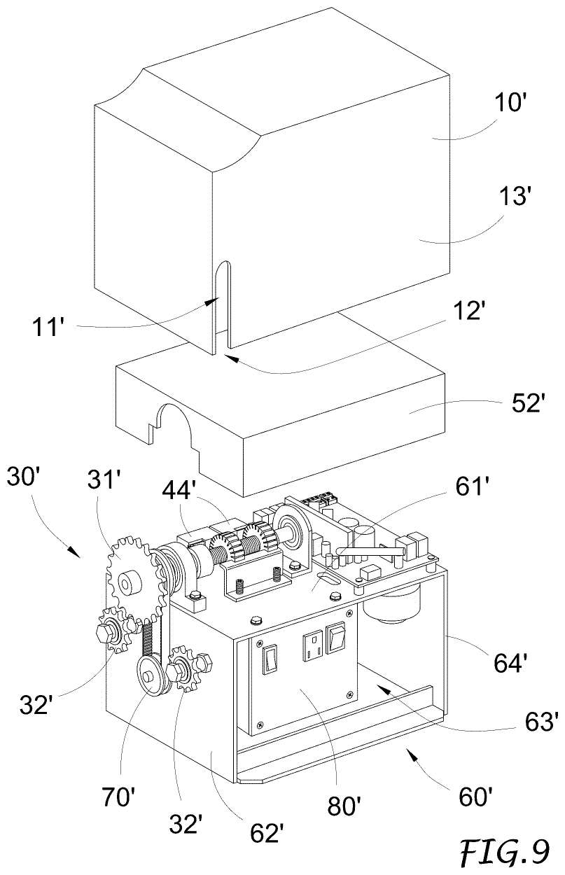

Referring to FIG. 9 of the drawings, the supporting frame 60′ may be accommodated in the receiving cavity 11′ and may be physically protected by the housing 10′. The supporting frame 60′ may comprise the top panel 61′, the gear panel 62′, and a rear panel 64′ provided opposite to the gear panel 62′. Thus, the gear panel 62′ may correspond to a front side of the supporting frame 60′, while the rear panel 64′ may correspond to a rear side thereof. The operation cavity 63′ may be formed in a space surrounded by the gear panel 62′, the top panel 61′ and the rear panel 64′.

The supporting frame 60′ may further have two openings 65′ formed on two sides of the supporting frame 60′. The operation cavity 63′ may communicate with the receiving cavity 11′ through the two openings 65′. A power control unit 80′ may be mounted in the operation cavity 63′, and may be accessed through the corresponding opening 65′. A user may be able to turn on or off the gate opening apparatus of the present invention by operating on the power control unit 80′.

The motor 20′ may be mounted on the supporting frame 60′ and may be supported in the operation cavity 63′. The motor 20′ may be configured as a synchronous motor and may be arranged to drive the gear assembly 30′ to rotate. A feature of the motor 20′ is that when the motor 20′ is connected to a power source, the motor 20′ may be arranged to possess a predetermined amount of mechanical resistance so as to prevent users from manually opening or closing the door gate 100. In other words, in normal situation, the door gate 100 will be fully controlled by the gate opening apparatus and users may be prevented from manually opening or closing the door gate 100 due to the mechanical resistance of the motor 20′.

The motor 20′ may have a driving shaft 21′ extending in the operation cavity 63′ and extending through the gear panel 61′. The driving member 70′ may be connected to the driving shaft 21′ on an outer side of the gear panel 61′ so that when the driving shaft 21′ is driven to rotate, the driving member 70′ is also driven to rotate accordingly. According to the second preferred embodiment of the present invention, the driving member 70′ may be configured as a driving pulley having a driving slot 71′. Furthermore, gate opening apparatus may further comprise a transmission belt 72′ mounted in the driving slot 71′ and may mechanically connect the driving member 70′ to the main gear 31′, in such a manner that when the driving member 70′ is driven to rotate, the main gear 31′ is also driven to rotate through the transmission belt 72′. The driving member 70′, the main gear 31′ and the transmission belt 72′ may be mounted on an outer side of the gear panel 61′, as shown in FIG. 8 to FIG. 11 of the drawings.

One skilled in the art may appreciate that the main gear 31′ may be driven by the motor 20′ through alternative mechanical methods. For example, the main gear 31′ may be directly connected to the motor 20′ without using the transmission belt 72′. These alternatives are also covered by the spirits of the present invention. The objective is for the motor 20′ to drive the main gear 31′ to rotate in a controlled manner.

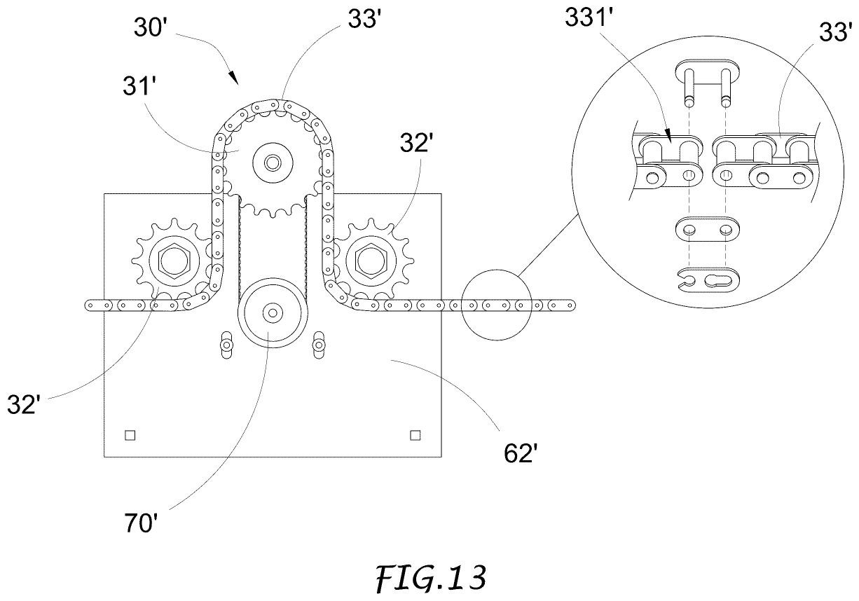

Each of the main gear 31′ and the driven gears 32′ may have a plurality of teeth 33′. On the other hand, the gear assembly 30′ may further comprise an actuation chain 33′ connecting the main gear 31′ to the driven gears 32′ and connecting the driven gears 32′ to the door gate 100. Referring to FIG. 13 of the drawings, the actuation chain 33′ may be configured as a metallic chain and may be configured as having a plurality of actuation slots 331′, wherein each of the actuation slots 331′ may be arranged to engage with the corresponding teeth 33′ so as to mechanically connect the main gear 31′ to the driven gear 32′ and to the door gate 100.

Thus, when the main gear 31′ is driven to rotate by the motor 20′ through the transmission belt 72′, the main gear 31′ may be arranged to drive the actuation chain 33′ to move so as to drive the driven gears 32′ to rotate as well. The actuation chain 33′ may also be engaged with the driven gears 32′ so that when the driven gears 32′ are driven to rotate, the rotational movement of the driven gears 32′ may drive door gate 100 to slide in a corresponding direction.

According to the second preferred embodiment of the present invention, the gear assembly 30′ may comprise two driven gears 32′ rotatably supported by the gear panel 62′ at a position below the main gear 31′. Moreover, the two driven gears 32′ may be provided on two sides of but underneath the main gear 31′ respectively.

Referring to FIG. 9 of the drawings, the gate opening apparatus may further comprise a range adjustment mechanism 40′ provided on the supporting frame 60′ for setting a range of motion of the man gear 31′ (and therefore the driven gears 32′ and the door gate 100). Specifically, the range adjustment mechanism 40′ may comprise a sliding shaft 41′ mounted on the top panel 61′ of the supporting frame 60′, and a first and a second adjustment sliders 42′, 43′ movably mounted on the sliding shaft 41′. The first adjustment slider 42′ and the second adjustment slider 43′ may be spaced apart from each other on the sliding shaft 41′, wherein a distance between the first adjustment slider 42′ and the second adjustment slider 43′ may dictate the range of motion on the part of the main gear 31′.

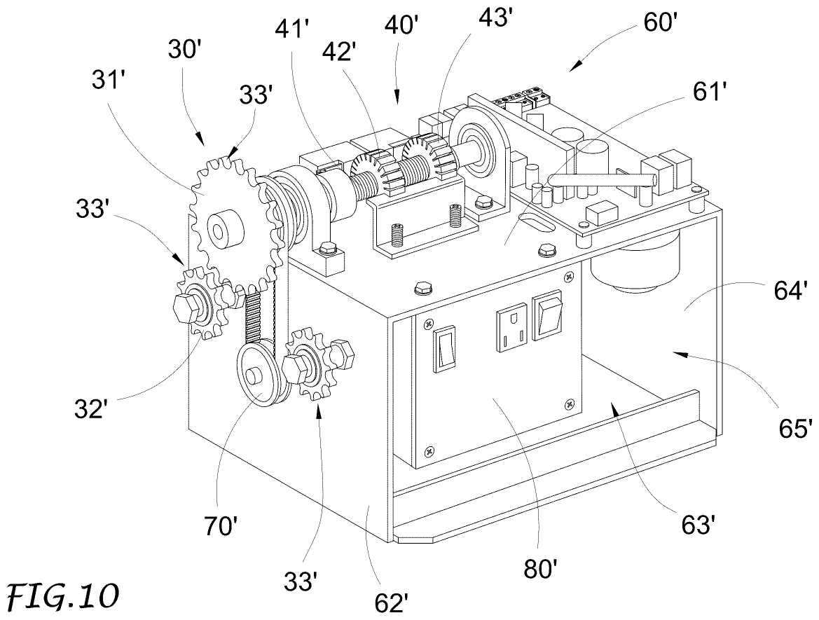

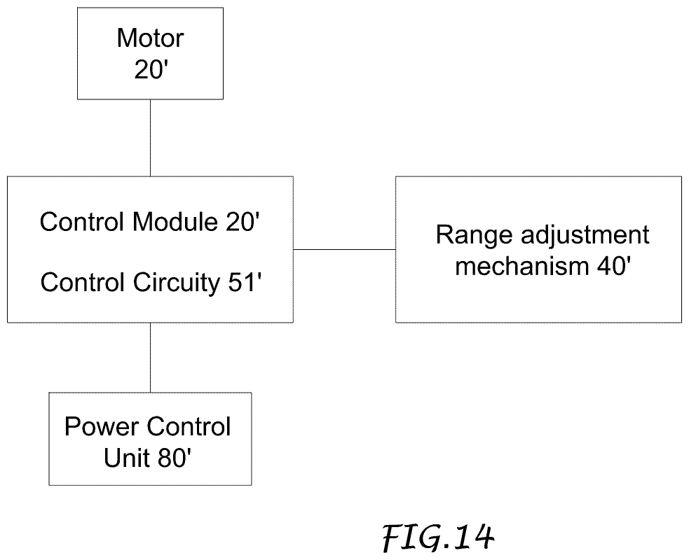

Referring to FIG. 10 of the drawings, each of the first adjustment slider 42′ and the second adjustment slider 43′ may be adjustably and slidably mounted on the sliding shaft 41′. As shown in FIG. 14 of the drawings, the gate opening apparatus may further comprise a control module 50′ which may comprise a control circuitry 51′ electrically connected to the motor 20′, the range adjustment mechanism 40′ and the power control unit 80′ for controlling a driving operation of the motor 20′. The control circuitry 51′ may be mounted and physically protected in a protective box 52′ on the top panel 61′ of the supporting frame 60′.

Furthermore, the control circuitry 51′ may be electrically connected to the motor 20′ so that it may activate the operation thereof. When the gate opening apparatus is in the power mode, the control circuitry 51′ may activate the motor 20′ so as to drive the motor 20′ to rotate in a predetermined direction. The rotation of the motor 20′ may drive the driving member 70′ and the main gear 31′ to rotate as well, and this in turn may drive the driven gears 32′ to rotate. Since the driven gears 32′ may be connected to the door gate 100 through the actuation chain 33′, the rotational movement of the motor 20′ may be eventually transformed into a linear sliding movement of the door gate 100 in the manner described above.

Furthermore, each of the first adjustment slider 42′ and the second adjustment slider 43′ may be electrically connected to the control circuitry 51′. The range adjustment mechanism 40′ may further comprise a plurality of motion sensors 44′ electrically connected to the control circuitry 51′ and mounted on the top panel 61′ of the supporting frame 60′ at positions adjacent to the sliding shaft 41′, wherein each of the first adjustment slider 42′ and the second adjustment slider 43′ may be in physical communication with the motion sensors 44′ so that when the first adjustment sider 42′ and the second adjustment slider 43′ are moved to predetermined positions on the sliding shaft 41′, the motion sensors 44′ may detect the presence of the first adjustment slider 42′ and the second adjustment slider 43′ and send electrical signals to the control circuitry 51′ for activating or deactivating the motor 20′. This may have the effect of stopping the rotation of the main gear 31′ and the driven gears 32′ for selectively actuating the sliding movement of the door gate 100.

Each of the motion sensors 44′ may be configured as a mechanical sensor having a resilient member 441′ such that when the corresponding first adjustment slider 41′ or the second adjustment slider 42′ is moved to bias against the resilient member 441′, the corresponding motion sensor 44′ may be activated to signal a corresponding signal to the control circuitry 51′ for stopping the operation of the motor 20′. Alternatively, each of the motion sensors 44′may be configured as a magnetic sensor wherein the first adjustment slider 41′ and the second adjustment slider 42′ may be in magnetic communication with the motion sensors 44 respectively.

The control circuitry 51′ may be configured to activate the motor 20′ to drive the main gear 31′ to rotate in a predetermined direction so as to drive the door gate 100 to slide in the corresponding direction for opening or closing the door gate 100.

In the power mode, the motor 20′ may be arranged to exert substantial resistance so that a user may not be able to manually pull or push the door gate 100′ for pivotally moving it. In other words, when the gate opening apparatus is in normal operation, manual opening or closing the door gate 100 will not be allowed.

When the gate opening apparatus is in the manual mode, the supply of electricity to the motor 20′ is cut off. The substantial resistance possessed by the motor 20′ will cease to exist without any involvement of clutching device so that a user is able to manually push or pull the door gate 100 so as to allow the door gate 100 to slide. It is important to mention that this feature is distinctive with respect to conventional gate opening apparatuses in which clutching devices must be used when electricity is cut off for allowing manual movement of the corresponding door gate.

The present invention, while illustrated and described in terms of a preferred embodiment and several alternatives, is not limited to the particular description contained in this specification. Additional alternative or equivalent components could also be used to practice the present invention.

What is claimed is:

1. A gate opening apparatus for a door gate, comprising:
a housing having a receiving cavity and an engagement slot communicating the receiving cavity with an exterior of the housing;
a supporting frame received in the receiving cavity, the supporting frame having a top panel, a gear panel, and an operation cavity formed underneath the top panel, the operation cavity communicating with the receiving cavity of the housing;
a motor supported by the supporting frame, and accommodated in the receiving cavity;
a driving member connected to the motor in a rotatably movable manner; and
a gear assembly, which comprises:
a main gear rotatably supported by the top panel of the supporting frame and connecting to the driving member, in such a manner that when the driving member is driven by the motor to rotate, the main gear is also driven to rotate; and
a plurality of driven gears rotatably mounted on the gear panel of the supporting frame, the driven gears connecting to the main gear and the door gate, so that when the main gear is driven to rotate, the driven gears are also driven to rotate and drive the door gate to slide; and
wherein the gate opening apparatus is arranged to be selectively operated between a power mode and a manual mode, wherein in the power mode, the motor is electrically activated to drive the driving member to rotate so as to drive the main gear to rotate so as to drive the driven gears to rotate and move the door gate to slide, wherein in the manual mode, the motor is cut off from electricity and is arranged to exert minimal mechanical resistance so that a user is able to manually slide the door gate for opening or closing thereof.

2. The gate opening apparatus, as recited in claim 1, wherein the motor is configured as a synchronous motor and is arranged to drive the gear assembly to rotate, in such a manner that when the motor is connected to a power source, the motor is arranged to possess a predetermined amount of mechanical resistance so as to prevent users from manually actuating the motor for opening or closing the door gate.

3. The gate opening apparatus, as recited in claim 2, wherein the supporting frame further comprises a rear panel provided opposite to the gear panel, so that the gear panel corresponds to a front side of the supporting frame, while the rear panel corresponds to a rear side thereof, the operation cavity being formed in a space surrounded by the gear panel, the top panel and the rear panel.

4. The gate opening apparatus, as recited in claim 3, wherein the motor has a driving shaft extending in the operation cavity and extending through the gear panel to connect to the driving member on an outer side of the gear panel so that when the driving shaft is driven to rotate, the driving member is also driven to rotate accordingly.

5. The gate opening apparatus, as recited in claim 4, further comprising a transmission belt, wherein the driving member is configured as a driving pulley having a driving slot, the transmission belt being mounted in the driving slot and mechanically connecting the driving member to the main gear, in such a manner that when the driving member is driven to rotate, the main gear is also driven to rotate through the transmission belt.

6. The gate opening apparatus, as recited in claim 5, wherein each of the main gear and the driven gears has a plurality of teeth, the gear assembly further comprising an actuation chain connecting the main gear to the driven gears and connecting the driven gears to the door gate.

7. The gate opening apparatus, as recited in claim 6, wherein the actuation chain is a metallic chain having a plurality of actuation slots, wherein each of the actuation slots is arranged to engage with the corresponding teeth so as to mechanically connect the main gear to the driven gear and to the door gate.

8. The gate opening apparatus, as recited in claim 7, wherein the gear assembly comprises a total of two driven gears rotatably supported by the gear panel at a position below the main gear, the two driven gears being provided on two sides of and underneath the main gear respectively.

9. The gate opening apparatus, as recited in claim 3, further comprising a range adjustment mechanism provided on the supporting frame, the range adjustment mechanism comprising a sliding shaft mounted on the top panel of the supporting frame, and a first and a second adjustment sliders movably mounted on the sliding shaft, the first adjustment slider and the second adjustment slider being spaced apart from each other on the sliding shaft, wherein a distance between the first adjustment slider and the second adjustment slider dictates a range of motion of the main gear.

10. The gate opening apparatus, as recited in claim 7, further comprising a range adjustment mechanism provided on the supporting frame, the range adjustment mechanism comprising a sliding shaft mounted on the top panel of the supporting frame, and a first and a second adjustment sliders movably mounted on the sliding shaft, the first adjustment slider and the second adjustment slider being spaced apart from each other on the sliding shaft, wherein a distance between the first adjustment slider and the second adjustment slider dictates a range of motion of the main gear.

11. The gate opening apparatus, as recited in claim 9, further comprising a control module electrically connected to the motor and the range adjustment mechanism, the range adjustment mechanism further comprising a plurality of magnetic transceivers electrically connected to the control module and mounted on the supporting frame at positions adjacent to the sliding shaft, wherein each of the first adjustment slider and the second adjustment slider is in magnetic communication with the magnetic transceivers so that when the first adjustment sider and the second adjustment slider are moved to predetermined positions on the sliding shaft, the magnetic transceivers are arranged to detect the presence of the first adjustment slider and the second adjustment slider respectively and send electrical signals to the control module for activating or deactivating the motor.

12. The gate opening apparatus, as recited in claim 10, further comprising a control module electrically connected to the motor and the range adjustment mechanism, the range adjustment mechanism further comprising a plurality of magnetic transceivers electrically connected to the control module and mounted on the supporting frame at positions adjacent to the sliding shaft, wherein each of the first adjustment slider and the second adjustment slider is in magnetic communication with the magnetic transceivers so that when the first adjustment sider and the second adjustment slider are moved to predetermined positions on the sliding shaft, the magnetic transceivers are arranged to detect the presence of the first adjustment slider and the second adjustment slider respectively and send electrical signals to the control module for activating or deactivating the motor.
